(19) United States
(12) Patent Application Publication
(10) Pub. No.: US 2012/0114270 A1
(43) Pub. Date: May 10, 2012

(54) Electromagnetic radiation attenuator pouch

(75) Inventor: Elizabeth Roberts, Seattle, WA (US)

(73) Assignee: WRAPHabillement

(21) Appl. No.: 12/925,993

(22) Filed: Nov. 4, 2010

(51) Int. Cl. B65D 30/08; B23P 19/00

(52) U.S. Cl. 383/109; 29/428

(57) ABSTRACT

An electromagnetic radiation attenuator pouch for a cell phone or other portable electronic device producing electromagnetic radiation emissions, the attenuator pouch formed of a pair of flaps coupled together along corresponding edges thereof, wherein each of the flaps includes at least a sheet of electromagnetic radiation buffering material operable for shielding against electromagnetic waves in at least one of a radio frequency (RF) band and a microwave frequency band. A pocket is formed between the pair of flaps spaced substantially equidistantly inwardly of the edges of the flaps for forming a radiation buffer zone between the pocket and the respective peripheral base and opposing side edges of the flaps. A mouth opening is formed between the pair of flaps along one peripheral edge thereof, and a lead-in guide is formed between the flaps and communicates between the mouth opening and the pocket.

### FIELD OF THE INVENTION

The present invention relates generally to electromagnetic radiation attenuation devices, and in particular to portable pockets or pouches for cellular telephones and other portable electronic devices producing electromagnetic radiation emissions, the portable pocket or pouch permitting operation of the cellular telephone or other portable electronic device while substantially attenuating electromagnetic radiation emissions therefrom.

### BACKGROUND OF THE INVENTION

Cell phones have been cited as one source of high amounts of electromagnetic radiation, yet people carry them around everywhere they go. There are an estimated 200+ million cell phone users in the U.S. alone, as many as 1.9 billion worldwide. Studies have linked cell phone radiation to health problems such as headaches, high blood pressure, brain tumors, cancer, Alzheimer's, and more. The electromagnetic radiation that cell phones emit is generally directed towards the closest part of the body. This radiation can cause irreparable long term health effects, especially in the brain and the reproductive system of the pelvic area. The body tissue in the lower body area has good conductivity and absorbs radiation more quickly than the head. One study shows that men who wear cell phones near their groin could have their sperm count dropped by as much as 30 percent. Scientists predict 500,000 new cases of brain and eye cancer each year attributable to cell phone use. Although there is a latency period for most diseases and it may take years and more studies before the required weight of evidence is established, but the deleterious effects are believed to be cumulative.

Proper shielding can help protect against electromagnetic radiation and the health problems it creates. There are different devices that can help to protect against the radiation in different manners.

Known hands-free cell phone devices help users by obviating the need to hold the phone right next to the head where it can cause the most damage. Also, known cell phone protection devices are designed to shield radiation while the cell phone is carried in the pocket or on the person while not in use or in use with a hands-free device. A combination of cell phone protection devices provides the best defense against electromagnetic radiation.

Several recommendations have been made for minimizing exposure to cell phone electromagnetic radiation. A list of recommendations made by EMF-Health.com, Advanced EMF Protection Solutions to the Dangers of Electropollution, includes not putting the cell phone in your pocket or belt while it is in use or while turned on. Another recommendation is use of a scientifically validated electromagnetic field (EMF) protection device. There are advanced technologies available nowadays that strengthen the body's bioenergy field and immune system against the effects of EMF. Even when not actively in use, the cell phone's ‘second-hand’ radiation can cause biological stress, so electromagnetic radiation protection devices are increasingly becoming essential.

However, known electromagnetic radiation protection devices are limited in their ability to provide the necessary protection quickly, easily, efficiently and reliably.

### SUMMARY OF THE INVENTION

The present invention is an electromagnetic radiation attenuator pouch for a cell phone or other portable electronic device producing electromagnetic radiation emissions.

According to one aspect of the invention, the electromagnetic radiation attenuator pouch is formed of a pair of flaps coupled together along corresponding peripheral base and opposing side edges thereof, wherein each of the flaps further comprising a sheet of electromagnetic radiation buffering material operable for shielding against electromagnetic waves in a predetermined radio frequency (RF) band and/or microwave frequency band. A pocket is formed between the pair of flaps, the pocket being spaced substantially equidistantly inwardly of the peripheral base and opposing side edges of the flaps for forming a radiation buffer zone between the pocket and the respective peripheral base and opposing side edges of the flaps. A mouth opening that is wider than the pocket is formed between the pair of flaps along a peripheral top edge thereof opposite from the peripheral base thereof and between the opposing side edges thereof, and a lead-in guide is formed between the flaps that communicates between the mouth opening and the pocket.

According to another aspect of the invention, the attenuator pouch further includes an outer environmental protection layer positioned external of the sheets of electromagnetic radiation buffering material. For example, the outer environmental protection layer is a substantially weather-proof material.

According to another aspect of the invention, the attenuator pouch further includes an inner damage protection layer positioned between the electromagnetic radiation buffering material of the flaps within the pocket. For example, the inner damage protection layer is a soft yet hard wearing, water and dirt repelling fabric.

According to another aspect of the invention, the attenuator pouch further includes a moisture protection layer positioned between the pocket and the electromagnetic radiation buffering material of the flaps. For example, the moisture protection layer positioned between the inner damage protection layer of the pocket and the electromagnetic radiation buffering material of the flaps. The moisture protection layer is, for example, a moisture wicking material.

According to another aspect of the invention, the attenuator pouch further includes both the outer environmental protection layer positioned external of the sheets of electromagnetic radiation buffering material of each of the flaps, and the inner damage protection layer positioned between the electromagnetic radiation buffering material of each of the flaps within the pocket. Optionally, the attenuator pouch also includes the intermediate moisture protection layer positioned between the inner damage protection layer of the pocket and the electromagnetic radiation buffering material of the flaps.

According to another aspect of the invention, a method is provided of forming an electromagnetic radiation attenuator pouch, wherein the method includes forming a pair of flaps of a sheet of electromagnetic radiation buffering material operable for shielding against electromagnetic waves in a predetermined radio frequency (RF) band and/or microwave frequency band, coupling the pair of flaps together along corresponding peripheral base and opposing side edges thereof, forming a pocket between the pair of flaps, forming a radiation buffer zone between the pocket and respective peripheral base and opposing side edges of the flaps, forming a mouth opening wider than the pocket between the pair of flaps along a peripheral top edge thereof opposite from the peripheral base thereof and between the opposing side edges thereof, and forming a lead-in guide communicating between the mouth opening and the pocket.

According to another aspect of the method of the invention, forming a radiation buffer zone between the pocket and respective peripheral base and opposing side edges of the flaps further includes spacing the pocket substantially equidistantly inwardly of the peripheral base and opposing side edges of the flaps.

According to another aspect of the method of the invention, forming the pair of flaps further includes forming the pair of flaps of an outer environmental protection layer positioned external of the sheets of electromagnetic radiation buffering material.

According to another aspect of the method of the invention, forming the pair of flaps further includes forming the pair of flaps of an inner damage protection layer positioned between the electromagnetic radiation buffering material of the flaps within the pocket.

According to another aspect of the method of the invention, forming the pair of flaps further includes forming the pair of flaps of an intermediate moisture protection layer positioned between the inner damage protection layer of each of the flaps and the sheet of electromagnetic radiation buffering material thereof.

According to another aspect of the method of the invention, forming the pair of flaps further includes forming the pair of flaps of an outer environmental protection layer positioned external of the sheets of electromagnetic radiation buffering material, and an inner damage protection layer positioned between the electromagnetic radiation buffering material of the flaps within the pocket. Optionally, an intermediate moisture protection layer is positioned between the inner damage protection layer of each of the flaps and the sheet of electromagnetic radiation buffering material thereof.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1, FIG. 2 and FIG. 3 are detailed views of an electromagnetic radiation attenuator pouch for a cell phone or other portable electronic device producing electromagnetic radiation emissions, wherein FIG. 1 is a front view, and FIGS. 2 and 3 are cross-section views taken through the attenuator pouch;

FIG. 4 is an exploded view of a flap portion of the attenuator pouch showing the various layers included in each of two opposing flaps forming the attenuator pouch; and

FIG. 5 illustrates operation of the electromagnetic radiation attenuator pouch of the invention.

### DETAILED DESCRIPTION OF PREFERRED EMBODIMENT

In the Figures, like numerals indicate like elements.

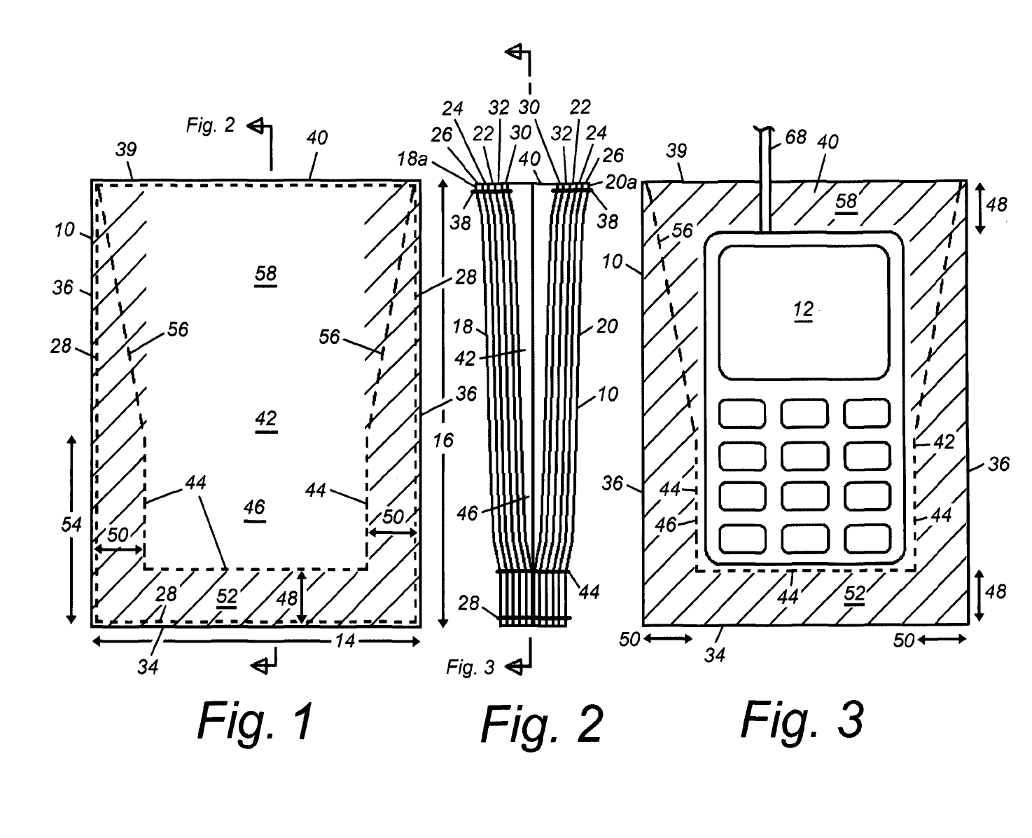

FIG. 1, FIG. 2 and FIG. 3 are detailed views of an electromagnetic radiation attenuator pouch 10 for a cell phone 12 or other portable electronic device (dashed) producing electromagnetic radiation emissions, as more clearly shown in FIG. 3.

The attenuator pouch 10 is shown having outside dimensions of about four (4) inches in width 14 by about (6) inches in height 16. However, the specific dimensions are optional and may be altered to suit the particular cell phone 12 or other electromagnetic radiation emission producing portable electronic device from which protection is desired.

The attenuator pouch 10 is formed by coupling together two opposing flaps 18 and 20 of fabric. Each flap 18, 20 of fabric includes at least one, and optionally two or more sheets 22 of electromagnetic radiation buffering material. Additional sheets 24 of electromagnetic radiation buffering material are optionally included in forming the attenuator pouch 10 for increasing the level of attenuation of electromagnetic radiation provided by the attenuator pouch 10. Additional sheets 24 of electromagnetic radiation buffering material thereby increase the protection from the cell phone 12 or any other portable electronic devices producing electromagnetic radiation emissions.

Optionally, additional layers of material may be added to one or both of the flaps 18, 20 that form the attenuator pouch 10. For example, outer environmental protection layers 26, for example a substantially weather-proof fabric, may be coupled to outside surfaces of the sheets 22 of electromagnetic radiation buffering material, either attached along peripheral lines of attachment 28, or otherwise adhered to the sheets 22 to form a substantially weather-proof outer surface of the attenuator pouch 10.

One or both of the flaps 18, 20 optionally also include one or more inner damage protection layers 30, for example a pleasantly soft and comfortable yet hard wearing, water and dirt repelling fabric that is also extremely easy to care for. The optional inner damage protection layers 30, when present, is positioned between the sheets 22 of electromagnetic radiation buffering material of the opposing flaps 18, 20 and captured therebetween along peripheral attachments 28. These optional soft inner damage protection layers 30, when present, receive the cell phone 12 or other device and act as a protective interface between the cell phone 12 and the layers 22, 24 of electromagnetic radiation buffering material.

Additionally, one or both of the flaps 18, 20 optionally include an intermediate moisture protection layer 32, for example a moisture wicking material, positioned between the optional soft inner damage protection layer 30 of hard wearing, water and dirt repelling fabric and the sheet 22 of electromagnetic radiation buffering material. This optional intermediate moisture protection layer 32, when present, is also captured therebetween along peripheral attachments 28, and operates to keep moisture from reaching the cell phone 12.

These weather-proof outer environmental protection layers 26, soft inner damage protection layers 30, and intermediate moisture protection layer 32 are all optional layers of one or both of the flaps 18, 20 and may eliminated without deviating from the scope and intent of the present invention.

The two opposing flaps 18, 20 of fabric are coupled together along peripheral attachments 28 to form the attenuator pouch 10. The peripheral attachments 28 are formed along the pouch's outer base edge 34, and its opposing outer side edges 36. When the flaps 18, 20 include multiple sheets 22 of electromagnetic radiation buffering material and/or one or more of the optional outer environmental protection layer 26, soft inner damage protection layer 30, and intermediate moisture protection layer 32, the multiple individual layers of the different flaps 18, 20 are coupled together by peripheral lines of attachment 38 along their individual top edges 18a and 20a, which together form the outer top edge 39 of the attenuator pouch 10. The peripheral attachments 28, 38 are formed, by example and without limitation, by stitching or other coupling means, such as gluing or stapling, suitable to the sheet 22 of buffering material.

The peripheral attachments 28 along the outer base edge 34 and outer side edges 36 form the attenuator pouch 10 leaving a mouth opening 40 in the pouch's outer top edge 35. The mouth opening 40 communicates with an interior pocket 42 that is sized to comfortably receive the cell phone 12. The interior pocket 42 is formed, by example and without limitation, by coupling together at least the two central facing sheets 22 of the electromagnetic radiation buffering material, and optionally all the layers of the two flaps 18, 20, along substantially parallel interior lines of attachment 44 to form a short blind channel 46 between at least the two central facing sheets 22 of electromagnetic radiation buffering material, and optionally between all the layers of the two flaps 18, 20. For example, the blind channel 46 is formed between the innermost damage protection layers 30 of soft and comfortable fabric that operates to protect the cell phone or other device 12 from scratching or other damage, yet is hard wearing and water and dirt repelling to remain undamaged by use over time.

The short blind channel 46 between the soft innermost damage protection layers 30 is terminated along the interior attachments 44 a short distance 48 upward from the outer base edge 34 of the attenuator pouch 10, and similarly short distances 50 inward from the two side edges 36. According to one embodiment, the short distance 48 is in the range of about one-half (½) inch or so upward from the outer base edge 34 of the attenuator pouch 10, and the similarly short distances 50 are in the range of about one-half (½) inch or so inward from the two side edges 36. Thus, the similarly short distances 48, 50 spacing the interior pocket 42 from the outer base and side edges 34, 36 of the attenuator pouch 10 form a radiation buffer zone 52 (crosshatch) around the interior pocket 42. As illustrated in FIG. 3, when the attenuator pouch 10 is proportionately sized to receive the cell phone or other device 12 past the mouth opening 40 into the interior pocket 42, the radiation buffer zone 52 (crosshatch) is extended between the cell phone 12 and the outer top edge 39 of the attenuator pouch 10 about the same distance 48 as the blind end of the channel 46 from the attenuator pouch's outer base edge 34. The radiation buffer zone 52 (crosshatch) is thus sized for completely encompassing the cell phone 12 within the attenuator pouch 10.

The interior attachments 44 forming the blind channel 46 portion of the interior pocket 42 extend a short distance 54 in the range of about two to three (2-3) inches or so upwardly from the outer base edge 34. The blind channel 46 portion of the interior pocket 42 is thus about one and one half (1½) inches to about two and one half (2½) inches long, and preferably about two (2) inches long according to one embodiment, but may be longer or shorter to suit the application.

Additional interior lines of attachment 56 extend diagonally from the mouth opening 40 in the pouch's outer top edge 35 at the two opposing outer side edges 36 to intersect with the blind channel 46 opposite from the base edge 34 of the attenuator pouch 10. These additional diagonal interior attachments 56 form a lead-in guide 58 that operates to funnel the cell phone or other device 12 into the interior pocket 42, which in turn, operates to position the cell phone or other device 12 in the approximate center of the attenuator pouch 10 within the radiation buffer zone 52 around the interior pocket 42. The lead-in 58 also operates to enlarge the space between the interior pocket 42 and the pouch's outer top edge 35, which provides access into the pouch 10 for the user's fingers to retrieve the cell phone or other device 12 therein.

The substantially parallel and diagonal interior attachments 44 and 56 forming the short blind channel 46 and the lead-in guide 58 are formed similarly to the peripheral attachments 28, 43, by example and without limitation, by stitching or other coupling means, such as gluing or stapling, suitable to the sheet 22 of buffering material and optional outer environmental protection layers 26, inner damage protection layers 30, and intermediate moisture protection layer 32, if present.

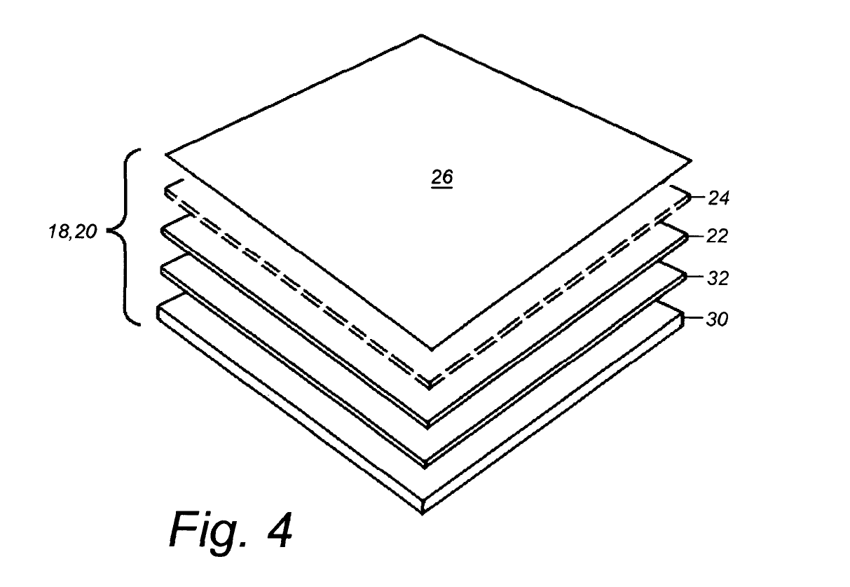

FIG. 4 is an exploded view showing the various layers included in each of the two opposing flaps 18, 20 forming the attenuator pouch 10. Each flap 18, 20 of the attenuator pouch 10 includes one, and optionally two or more of the sheets 22 of electromagnetic radiation buffering material. The electromagnetic radiation buffering material is, for example, a flexible textile fabric capable of shielding against electromagnetic radiation waves in the radio frequency (RF) and/or microwave frequency bands emitted by the cell phone or other portable electronic device 12 during operation. For example, the sheets 22 of electromagnetic radiation buffering material are a flexible textile fabric having substantially orthogonally crossing warp threads and weft threads made of spun mixed yarn of stainless steel fibers and textile fibers.

According to one embodiment, the sheets 22 of electromagnetic radiation buffering material are formed of STATICOT™ shielding fabric available from LessEMF, Albany, N.Y., USA. STATICOT™ shielding fabric is a polyester/cotton blend with microfine stainless steel fibers in a tough fabric similar to khaki, specifically a blend of 34 percent polyester, 41 percent combed cotton and 25 percent high shielding metal fiber, which is washable, cuttable and sewable. This fabric has a surface conductivity of 20 Ohm per square, so it provides static discharge and makes easy ground connections. Nearly 40 dB tested up to 10 GHz 230 g/square meter. This fabric is recommended for grounding applications, including seat covers and garments.

One alternative fabric for the sheets 22 electromagnetic radiation buffering material is ArgenMesh, also available from LessEMF, which provides the conductivity and shielding performance of silver with the strength of nylon, and is specifically a 55 percent silver and 45 percent nylon. Greater than 60 dB from 10 MHz to 40 GHz and surface conductivity of less than 0.5 Ohm per square, so it provides high level grounding, static discharge, electric field shielding, and radiofrequency shielding. This fabric is safe for skin contact, so it can be used in garments, or bedding.

Other alternative fabric for the sheets 22 electromagnetic radiation buffering material include, by example and without limitation, a nonwoven conductive fabric sheet disclosed by Kanamura, et al. in U.S. Pat. No. 4,943,477, which is incorporated herein by reference, which is a conductive sheet consisting of a nonwoven fabric consisting of 40 to 90 weight percent of a heat fusible fiber comprising a vinyl chloride/vinyl acetate copolymer and 10 to 60 weight percent of a metal-plated fiber having a fiber diameter of 3 to 50 micrometers and an aspect ratio of 1,000 to 10,000, wherein the nonwoven fabric is hot-press molded and wherein the conductive sheet has a metal content of 2 to 30 percent by weight and a specific volume of at most 2 centimeter cubed/gram. The conductive sheet provides electromagnetic interference shielding and electrical control effects. Another alternative fabric for the sheets 22 electromagnetic radiation buffering material is disclosed by Dordevic in U.S. Pat. No. 5,103,504, which is incorporated herein by reference, which is a textile fabric shielding electromagnetic radiation made of threads spun of textile fibers, containing cotton, and of steel fibers having a diameter of 6 to 10 micrometers. The number of mixed yarn threads in warp direction and in weft direction each is 18 to 20 threads per centimeter, and the yarn fineness of the textile fabric is especially 36 to 40 tex. The textile fabric guarantees a shielding of 20 to 40 dB against clothing thereof protect people, especially people wearing pacemakers, or hospital and radar personnel, against electromagnetic radiation. Yet another alternative fabric for the sheets 22 electromagnetic radiation buffering material is disclosed by Niioka in U.S. Pat. No. 5,198,290, which is incorporated herein by reference, which is an electromagnetic wave shielding material comprising a flexible base fabric, a first metallic film formed by flame-spraying a metal such as zinc on one side of the flexible base fabric and a second metallic film such as an aluminum foil formed on the other side of the flexible base fabric. The first metallic film does not peel after long lapse of time and can provide sufficient shielding effect to be used in unechoic chambers, etc. Alternative proprietary fabrics are also contemplated for the sheets 22 electromagnetic radiation buffering material. Accordingly, alternative fabrics for the sheets 22 electromagnetic radiation buffering material are also contemplated and may be substituted without deviating from the scope and intent of the present invention.

The optional outer environmental protection layers 26, when present, is coupled to outside surfaces of the sheets 22 of electromagnetic radiation buffering material and may be formed of any substantially weather-proof material, including by example and without limitation, Reflex™ fabric available from Schoeller®, Switzerland, which is formed of an ultra-thin and flexible hydrophilic membrane that repels rain and wind, and disperses body vapor build-up via molecular pathways within the membrane, and provides a total weather-proofness, breathability and high level of durability for very wet and rugged environments. However, alternative fabrics are also contemplated for the optional outer environmental protection layers 26 and may be substituted without deviating from the scope and intent of the present invention.

The optional inner damage protection layers 30, when present, is coupled between the sheets 22 of electromagnetic radiation buffering material of the opposing flaps 18, 20, Soft-Shell fabric also available from Schoeller®, which is highly elastic, extremely hard wearing, water and dirt repelling as well as easy to care for, and may be tailored for different application or clothing types. However, alternative fabrics are also contemplated for the optional inner damage protection layers 30 and may be substituted without deviating from the scope and intent of the present invention.

The optional intermediate moisture protection layer 32 of moisture wicking material, when present, is coupled between the optional soft inner damage protection layer 30 of hard wearing, water and dirt repelling fabric and the sheet 22 of electromagnetic radiation buffering material. The optional intermediate moisture protection layer 32 of moisture wicking material is, by example and without limitation, Dryskin fabric also available from Schoeller®, which is a double fabric construction developed especially for active sports and consists of synthetic fibers on the outside and function fibers on the inside for rapid moisture transport, which supports physical performance capacity during sporting activities, for example. Basic properties of the Dryskin fabric include, breathability, wind and water repellency, permanent elasticity, hard wearing durability, moisture transportation, functional fibers, fast dryability, and a high level of comfort when used in clothing. However, alternative moisture wicking fabrics are also contemplated for the optional intermediate moisture protection layer 32 and may be substituted without deviating from the scope and intent of the present invention.

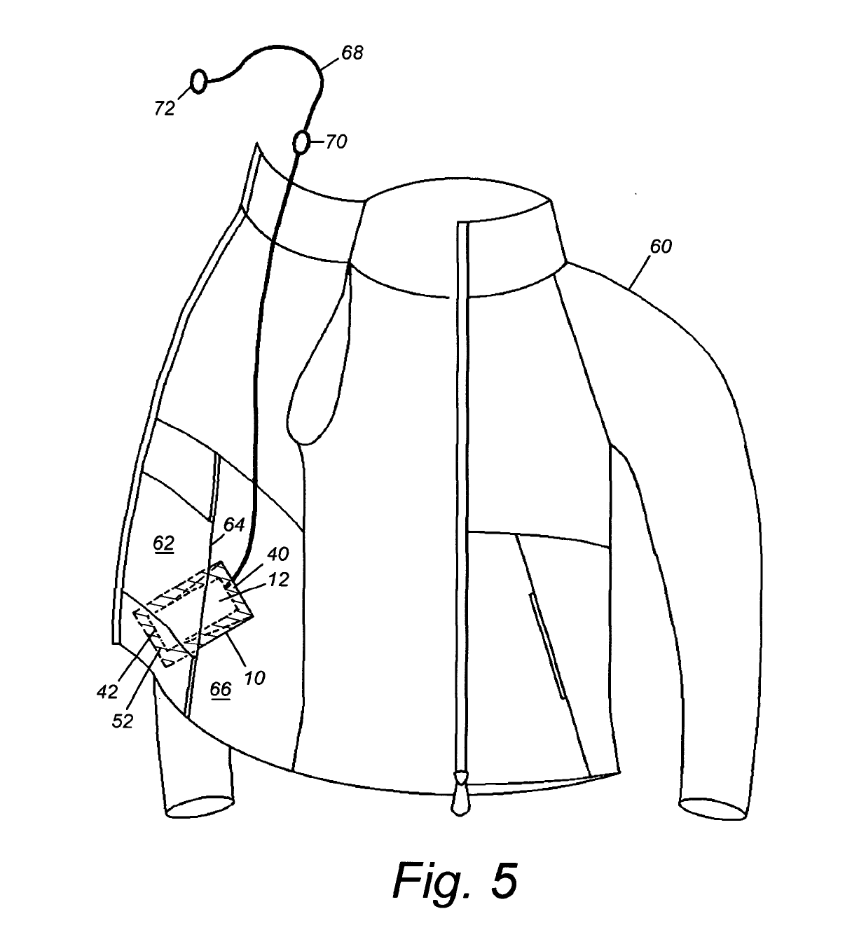

FIG. 5 illustrates operation of the electromagnetic radiation attenuator pouch 10 for shielding against the electromagnetic radiation emissions of a cell phone 12 or other portable electronic device (dashed) producing electromagnetic radiation emissions, as more clearly shown in FIG. 3. Here, a jacket (shown) or other article of clothing 60 includes a pocket 62 which, by example and without limitation, has an opening 64 through the lining or inside surface 66 of the jacket 14. However, the attenuator pouch 10 and cell phone 12 are alternately carried in any convenient place on the user's personal apparel or accessory, such as a backpack or handbag.

The attenuator pouch 10 is demonstrated as being slipped at least partially into the jacket's pocket 62 and carried therein in a generally upright orientation with the cell phone 12 protected therein. A hands-free device 68, such as a wireless Bluetooth or wired headset (shown) with microphone 70 and ear piece 72 communicates with the cell phone or other device 12 through the mouth opening 40 into the attenuator pouch 10. Furthermore, the attenuator pouch 10 is constructed using materials that attenuate substantially all of the electromagnetic radiation emitted by the cell phone or other portable electronic device during operation. However, signals in the RF and/or microwave frequency band of the cell phone or other device 12 can be sent and received through the opening 40. Accordingly, the pouch 10 attenuates electromagnetic radiation emitted by the cell phone 12 or other portable electronic device and protects the user and others in the vicinity from virtually all electromagnetic radiation, while permitting the device to operate normally for sending and receiving signals. Thus, the attenuator pouch 10 provides a first line of defense against electromagnetic radiation emissions from the cell phone 12 or other portable electronic device by attenuating electromagnetic radiation emitted by the cell phone 12, and a second line of defense by distancing the device 12 from the user's head and brain.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. An electromagnetic radiation attenuator pouch, comprising:
a pair of flaps coupled together along corresponding peripheral edges thereof, wherein each of the flaps further comprising a sheet of electromagnetic radiation buffering material operable for shielding against electromagnetic waves in a predetermined frequency band;
a blind channel formed between the pair of flaps, the channel being spaced inwardly of the peripheral edges of the flaps; and
a mouth opening between the pair of flaps along one peripheral edge thereof.

2. The attenuator pouch of claim 1, wherein the channel is spaced inwardly of the peripheral edges of the flaps for further forming a radiation buffer zone around the channel.

3. The attenuator pouch of claim 2, wherein the mouth opening is substantially wider than the channel; and
further comprising a lead-in guide communicating between the mouth opening and the blind channel.

4. The attenuator pouch of claim 3, wherein at least one of the flaps further comprises an outer environmental protection layer positioned external of the channel formed therebetween.

5. The attenuator pouch of claim 4, wherein the outer environmental protection layer further comprises a substantially weather-proof material.

6. The attenuator pouch of claim 3, wherein at least one of the flaps further comprises an inner damage protection layer positioned between the electromagnetic radiation buffering material of the flaps.

7. The attenuator pouch of claim 6, wherein the inner damage protection layer further comprises a soft yet hard wearing, water and dirt repelling fabric.

8. The attenuator pouch of claim 3, wherein at least one of the flaps further comprises a moisture protection layer positioned between the electromagnetic radiation buffering material of the flaps.

9. The attenuator pouch of claim 8, wherein the moisture protection layer further comprises a moisture wicking material.

10. The attenuator pouch of claim 3, wherein each of the flaps further comprises an outer environmental protection layer positioned external of the channel formed therebetween, and an inner damage protection layer positioned opposite from the outer environmental protection layer with the sheet of electromagnetic radiation buffering material positioned between the outer environmental protection layer and the inner damage protection layer.

11. The attenuator pouch of claim 10, wherein each of the flaps further comprises an intermediate moisture protection layer positioned between the inner damage protection layer and the sheet of electromagnetic radiation buffering material.

12. An electromagnetic radiation attenuator pouch, comprising:
a pair of flaps coupled together along corresponding peripheral base and opposing side edges thereof, wherein each of the flaps further comprising a sheet of electromagnetic radiation buffering material operable for shielding against electromagnetic waves in at least one of a radio frequency (RF) band and a microwave frequency band;
a pocket formed between the pair of flaps, the pocket being spaced substantially equidistantly inwardly of the peripheral base and opposing side edges of the flaps for forming a radiation buffer zone between the pocket and the respective peripheral base and opposing side edges of the flaps;
a mouth opening between the pair of flaps along a peripheral top edge thereof opposite from the peripheral base thereof and between the opposing side edges thereof, the mouth opening being wider than the pocket; and
a lead-in guide communicating between the mouth opening and the pocket.

13. The attenuator pouch of claim 12, further comprising an outer environmental protection layer positioned external of the sheets of electromagnetic radiation buffering material.

14. The attenuator pouch of claim 12, further comprising an inner damage protection layer positioned between the electromagnetic radiation buffering material of the flaps within the pocket.

15. The attenuator pouch of claim 12, further comprising a moisture protection layer positioned between the pocket and the electromagnetic radiation buffering material of the flaps.

16. The attenuator pouch of claim 12, further comprising an outer environmental protection layer positioned external of the sheets of electromagnetic radiation buffering material of each of the flaps, and an inner damage protection layer positioned between the electromagnetic radiation buffering material of each of the flaps within the pocket.

17. The attenuator pouch of claim 16, further comprising an intermediate moisture protection layer positioned between the inner damage protection layer of each of the flaps and the sheet of electromagnetic radiation buffering material thereof.

18. A method of forming an electromagnetic radiation attenuator pouch, comprising:
of a sheet of electromagnetic radiation buffering material operable for shielding against electromagnetic waves in at least one of a radio frequency (RF) band and a microwave frequency band, forming a pair of flaps;
coupling the pair of flaps together along corresponding peripheral base and opposing side edges thereof;
forming a pocket between the pair of flaps;
forming a radiation buffer zone between the pocket and respective peripheral base and opposing side edges of the flaps;
forming a mouth opening between the pair of flaps along a peripheral top edge thereof opposite from the peripheral base thereof and between the opposing side edges thereof, wherein the mouth opening is wider than the pocket; and
forming a lead-in guide between the flaps, the lead-in guide communicating between the mouth opening and the pocket.

19. The method of claim 18, wherein forming a radiation buffer zone between the pocket and respective peripheral base and opposing side edges of the flaps further comprises spacing the pocket substantially equidistantly inwardly of the peripheral base and opposing side edges of the flaps.

20. The method of claim 18, wherein forming a pair of flaps further comprises forming the pair of flaps of an outer environmental protection layer positioned external of the sheets of electromagnetic radiation buffering material.

21. The method of claim 18, wherein forming a pair of flaps further comprises forming the pair of flaps of an inner damage protection layer positioned between the electromagnetic radiation buffering material of the flaps within the pocket.

22. The method of claim 21, wherein forming a pair of flaps further comprises forming the pair of flaps of an intermediate moisture protection layer positioned between the inner damage protection layer of each of the flaps and the sheet of electromagnetic radiation buffering material thereof.

23. The method of claim 18, wherein forming a pair of flaps further comprises forming the pair of flaps of an outer environmental protection layer positioned external of the sheets of electromagnetic radiation buffering material, and an inner damage protection layer positioned between the electromagnetic radiation buffering material of the flaps within the pocket.

24. The method of claim 23, wherein forming a pair of flaps further comprises forming the pair of flaps of an intermediate moisture protection layer positioned between the inner damage protection layer of each of the flaps and the sheet of electromagnetic radiation buffering material thereof.
